(19) United States
(12) Patent Application Publication
(10) Pub. No.: US 2005/0115246 A1
(43) Pub. Date: Jun. 2, 2005

(54) Outdoor microturbine engine having water and oil separator

(75) Inventor: Kim Alan Bellingrath, Hampton, NH (US)

Correspondence Address: MICHAEL BEST & FRIEDRICH, LLP, 100 E WISCONSIN AVENUE, MILWAUKEE, WI, 53202, US

(73) Assignee: Ingersoll-Rand Energy Systems Corporation, Portsmouth, NH (US)

(21) Appl. No.: 10/725,046

(22) Filed: Dec. 1, 2003

(51) Int. Cl. F02C 7/10

(52) U.S. Cl. 60/772; 60/39.511

(57) ABSTRACT

An outdoor microturbine engine assembly includes a microturbine engine supported by a base and enclosed by an enclosure. The base defines a reservoir for the collection of rain water and any oil that may leak from the engine into the reservoir. The oil will naturally float on the water in the reservoir. A drain pipe communicates with the bottom of the reservoir and drains water from the bottom of reservoir while maintaining the oil in the reservoir.

### FIELD OF THE INVENTION

The invention relates to an outdoor microturbine engine having a water and oil separator.

### BACKGROUND

Microturbine engines are used as relatively efficient sources of electricity and can be used in connection with the power grid or in a stand-alone mode. Because of their size and flexibility, microturbine engines are often used in field applications. Also, where a microturbine engine is used to supply electrical power to a building, it may be placed outside of building to maximize the use of the space within the building for other purposes.

### SUMMARY

The invention provides an outdoor microturbine assembly that includes a recuperated microturbine engine, a chassis supporting the engine and having side walls that define a reservoir, and a drain pipe for draining liquids from the reservoir. The drain pipe extends through an upper portion of one of the walls of the chassis at a drain level that is lower than the lowest portion of any of the side walls. The drain pipe angles downwardly to communicate with a bottom portion of the reservoir such that, when the combined volume of water and high-density liquids reaches the drain level, water from the bottom of the reservoir drains out of the drain pipe while the high-density liquids float on top of water and remain in the reservoir.

Other features and advantages of the invention will become apparent to those skilled in the art upon review of the following detailed description, claims, and drawings.

### BRIEF DESCRIPTION OF THE DRAWINGS

FIG. 1 is a perspective view of an outdoor microturbine engine.

FIG. 2 is an exploded view of the outdoor microturbine engine.

FIG. 3 is a cross-sectional view of a portion of the drain pipe in the microturbine base.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

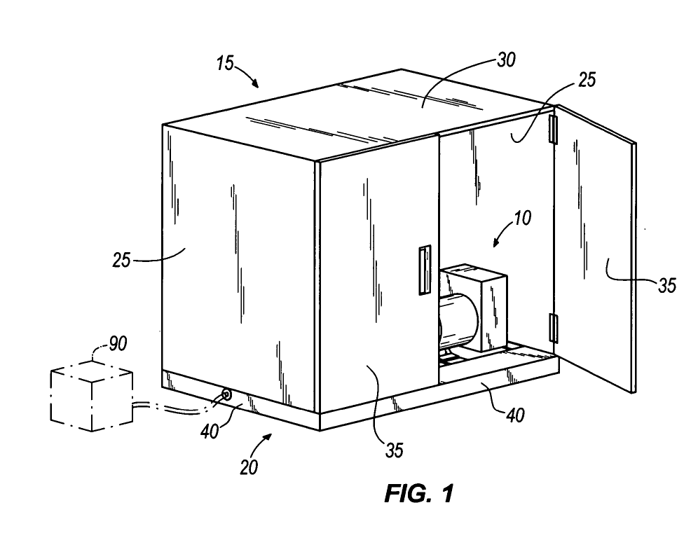

FIG. 1 illustrates a microturbine engine 10 contained in an enclosure 15 suitable for outdoor use. The enclosure 15 includes a base or chassis 20, enclosure walls 25 extending up from the base 20, and a top 30 supported by the enclosure walls 25. At least one access door 35 is provided in the enclosure walls 25 or may alternatively be in the top 30 of the enclosure 15 to provide access to the microturbine engine 10 from the top. When the access door 35 is closed, the enclosure 15 protects the engine 10 from the elements in a substantially weather resistant fashion. As used herein, the term “weather resistant” means that rain and other precipitation are prevented from reaching the engine 10 under normal conditions. For example, any vent openings in the enclosure 15 have hoods or shields that substantially prevent rain from entering the vent when the rain is falling vertically downward as in a typical rain shower, or when rain is falling at slight angles, as in a rain shower coupled with windy conditions.

The base 20 includes side walls 40 that define a reservoir below the microturbine engine 10. Inside the reservoir are a plurality of mounting points 45 for the microturbine engine 10 components. Any rain water or other precipitation that happens to enter the enclosure 15 (e.g., when the access doors 35 are left open or not shut properly) is collected in the reservoir.

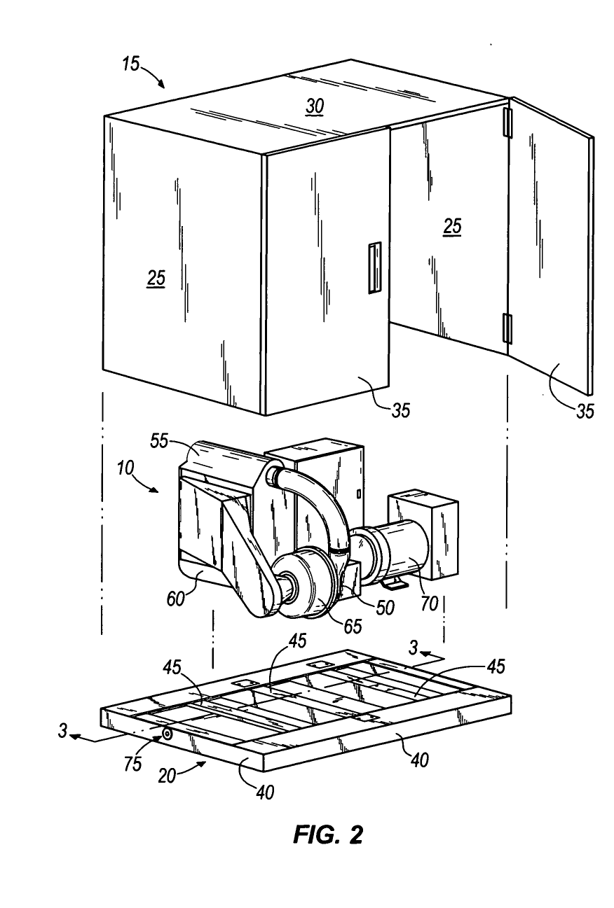

With reference to FIG. 2, the microturbine engine 10 includes a compressor 50, a recuperator 55, a combustor 60, a power turbine 65, and a generator 70. The compressor 50 is used to compress air and deliver it to the recuperator 55. The recuperator 55 is a heat exchanger that heats the compressed air before it reaches the combustor 60. The combustor 60 is within one of the manifolds of the recuperator 55. A fuel is mixed with the heated compressed air and the mixture is combusted in the combustor 60. The expanding products of combustion from the combustor 60 cause a rotating element of the power turbine 65 to rotate. The rotating element drives the generator 70 to generate electricity. It will be appreciated that microturbine engines may include a single spool for driving both the compressor and the power turbine or dedicated spools for each of those elements. It should also be appreciated that the invention contemplates radial or axial flow compressors and power turbines.

The products of combustion are still quite hot as they exit the power turbine 65, and they are routed back through the recuperator 55 to preheat the incoming compressed air. The gases are typically still hot when they exit the recuperator 55, and may be used for another purpose (e.g., the co-generation of hot water) before ultimately being exhausted to the atmosphere.

As used herein, the term “high-density liquid” means any liquid having a specific gravity greater than that of water (i.e., greater than 1). The microturbine engine 10 uses lubricants, oils, coolants, and other substances that qualify as “high-density liquids” for the purposes of this invention. Because the specific gravity of high-density liquids is larger than the specific gravity of water, the high-density liquids will float on top of the water in the reservoir.

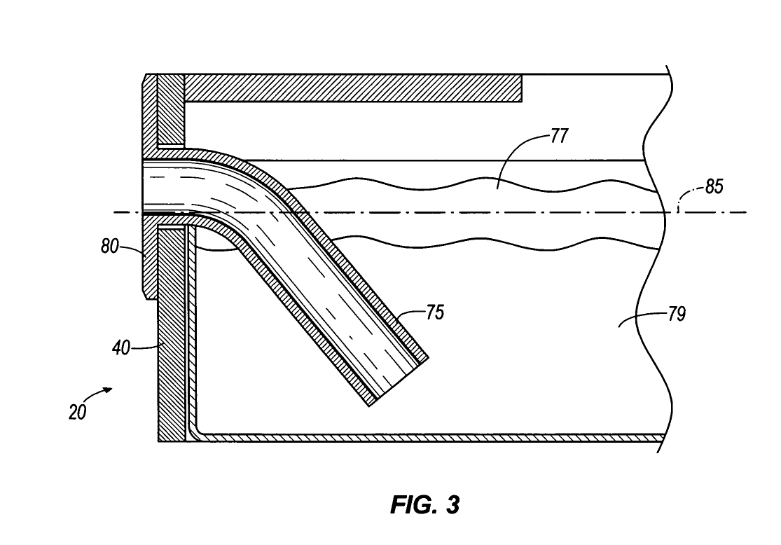

With reference to FIG. 3, a drain pipe 75 extends through the top portion of one of the side walls 40 of the base 20. The drain pipe 75 angles downwardly to the bottom of the reservoir beneath any layer of high-density liquids 77 that may have collect in the reservoir and float on the water 79 in the reservoir. A plate 80 is either integral with the pipe 75 or welded or otherwise affixed to the pipe 75. The plate 80 is mounted to the outside of the base 20 with suitable fasteners or is welded as illustrated. The plate 80 preferably provides a substantially water-tight seal around the opening in the side wall 40 of the base 20 so that liquids cannot escape the reservoir except through the drain pipe 75.

A drain level 85 is defined as the horizontal plane extending through the bottom edge of the hole in the side wall 40 through which the drain pipe 75 extends. Thus, when the water and high-density liquids level in the reservoir reaches the drain level 85, water 79 from the bottom of the reservoir will flow out of the drain pipe 75 and the high-density liquids 77 floating on top of the water will remain in the reservoir. A small amount of high-density liquid may enter the drain pipe 75 as the reservoir is initially filled, but that amount is considered negligible in comparison to the total volume of high-density liquid 77 in the reservoir. It should be noted that several drain pipes 75 may be used in the various side walls 40 of the base 20. This is particularly useful if the reservoir is divided in a way that restrains or prevents communication between portions of the reservoir. In that case, one or more pipes 75 may be dedicated to each portion of the reservoir.

The drain level 85 defines the volumetric capacity of the reservoir. That is to say that the reservoir will contain up to the volume of liquids necessary to overflow the drain level 85 and spill out of the drain pipe 75. The total volume of high-density liquids in the engine is preferably lower than the volumetric capacity of the reservoir, such that if all high-density liquids used by the engine were to drain into the reservoir, the volume of high-density liquids alone would not reach the drain level 85.

The end of the drain pipe 75 that extends through the side wall 40 of the base 20 includes a tapered pipe thread adapted to communicate with a liquid pump 90 (shown schematically in phantom in FIG. 1). The pump 90 may be attached to the drain pipe 75 and used to pump most of the liquids out of the reservoir.

1. An outdoor microturbine assembly comprising:
an engine including a compressor providing a flow of compressed air; a recuperator preheating the flow of compressed air with a flow of hot waste gases; a combustor mixing the preheated flow of compressed air with a fuel and combusting the mixture to create a flow of products of combustion; a turbine element that rotates in response to the flow of products of combustion and exhausting the flow of hot waste gases into the recuperator; and a generator generating electricity in response to rotation of the turbine element;
a chassis supporting the engine and having side walls that define a reservoir; and
a drain pipe extending through an upper portion of one of the walls of the chassis at a drain level that is lower than the lowest portion of any of the side walls, the drain pipe angling downwardly to communicate with a bottom portion of the reservoir;
wherein any liquids having a specific gravity greater than that of water float on top of the collection of any water in the reservoir; and
wherein water from the bottom portion of the reservoir is forced out of the drain pipe upon the level of water and other liquids in the reservoir rising above the drain level.

2. The microturbine of claim 1, wherein the drain pipe includes a plate integrally formed with the end of the drain pipe extending through the side wall of the chassis, and wherein the plate is mounted to an exterior surface of the side wall of the chassis.

3. The microturbine of claim 1, wherein the end of the drain pipe extending through the side wall of the chassis includes a tapered pipe thread.

4. The microturbine of claim 3, further comprising a liquid pump interconnectable to the drain pipe through the tapered pipe thread and operable to pump substantially all liquids from the reservoir through the drain pipe.

5. The microturbine of claim 1, further comprising an enclosure mounted on the chassis and surrounding the engine; the enclosure including at least one access door that is selectively opened and closed to respectively provide and deny access to the engine; wherein the enclosure substantially prevents rain water from entering the enclosure and reaching the engine when the door is closed.

6. The microturbine of claim 1, wherein the engine uses a volume of high-density liquids having a specific gravity greater than that of water, and wherein the reservoir has a volumetric capacity at least equal to the volume of high-density liquids in the engine.

7. The microturbine of claim 1, wherein the engine uses a volume of lubricant and a volume of coolant each having a specific gravity greater than that of water, and wherein the reservoir has a volumetric capacity at least equal to the combined volumes of lubricant and coolant.

8. A method for controlling the drainage of liquids from a microturbine system, the method comprising the steps of:
providing an engine including a compressor providing a flow of compressed air; a recuperator preheating the flow of compressed air with a flow of hot waste gases; a combustor mixing the preheated flow of compressed air with a fuel and combusting the mixture to create a flow of products of combustion; a turbine element that rotates in response to the flow of products of combustion and exhausting the flow of hot waste gases into the recuperator; and a generator generating electricity in response to rotation of the turbine element;
providing a chassis having side walls that define a reservoir;
supporting the engine from underneath with the chassis;
collecting in the reservoir water and high-density liquids having a specific gravity greater than that of water;
permitting the high-density liquids to float on top of the water in the reservoir; and
removing water from the bottom portion of the reservoir upon the level of water and other liquids in the reservoir exceeding a preselected drain level, while retaining the high-density liquids in the reservoir.

9. The method of claim 8, wherein the providing a chassis step includes extending a drain pipe through an upper portion of one of the side walls of the chassis such that the drain pipe communicates between the environment external of the chassis and a bottom portion of the reservoir; and wherein the removing water step includes establishing as the drain level the level at which the drain pipe extends through the side wall, and permitting water to drain out of the drain pipe from the bottom of the reservoir.

10. The method of claim 9, wherein the drain pipe includes a plate integrally formed with the end of the drain pipe extending through the side wall of the chassis, and wherein the providing a chassis step includes mounting the plate to an exterior surface of the side wall of the chassis.

11. The method of claim 9, wherein the end of the drain pipe extending through the side wall of the chassis includes a tapered pipe thread, and wherein the removing water step includes interconnecting a pump to the drain pipe via the pipe threads and pumping water out of the chassis with the pump.

12. The method of claim 8, further comprising providing an enclosure, and surrounding the engine with the enclosure in a weather resistant fashion.

13. The method of claim 8, wherein the engine uses a volume of high density liquids having a specific gravity greater than that of water; and wherein the providing a chassis step includes defining the reservoir to have a volumetric capacity greater than the volume of high-density liquids in the engine.
